(19) United States
(12) Patent Application Publication
(10) Pub. No.: US 2009/0316869 A1
(43) Pub. Date: Dec. 24, 2009

(54) INFORMATION PROCESSING DEVICE, ADVERTISING TRANSMISSION METHOD, PROGRAM PRODUCT, AND SYSTEM

(75) Inventors: Shinya Nakamoto, Tokyo (JP); Takuo Tsuruta, Tokyo (JP); Daisuke Inokoshi, Tokyo (JP); Takashi Ishiuchi, Tokyo (JP); Toru Shintani, Tokyo (JP)

Correspondence Address: ARENT FOX LLP, 1050 CONNECTICUT AVENUE, N.W., SUITE 400, WASHINGTON, DC, 20036, US

(73) Assignee: NS SOLUTIONS CORPORATION, Tokyo (JP)

(21) Appl. No.: 12/518,796

(22) PCT Filed: Jan. 31, 2008
(86) PCT No.: PCT/JP2008/051541

§ 371 Date: Jun. 11, 2009

(30) Foreign Application Priority Data
Feb. 1, 2007 (JP) 2007-023234

(51) Int. Cl. H04M 1/56

(52) U.S. Cl. 379/142.06

(57) ABSTRACT

A determination unit determining whether or not a telephone number of a called side included in a received telephone call control signal is registered in an advertising contract object that is stored in a memory unit and that includes a telephone number of an advertising contractant who performs a contract with an advertising provider and advertising provider identification information identifying the advertising provider with whom the advertising contractant performs the contract, an extraction unit extracting advertising data of the advertising provider identified by the advertising provider identification information corresponding to the telephone number of the called side from a memory unit when the telephone number of the called side is determined to be registered in the advertising contract object in the determination unit, and an advertising data transmission control unit transmitting the advertising data extracted in the extraction unit to a telephone apparatus identified by a telephone number of a calling side included in the telephone call control signal are included.

### TECHNICAL FIELD

The present invention relates to an information processing device, an advertising transmission method, a program product, and a system.

### BACKGROUND ART

There is an art providing an announcement such as commercial information to a calling party when transmitting a telephone call (see, for example, Patent Document 1). Patent Document 1 discloses the art with regard to a service mode in which the calling party enjoys advantage such as making a telephone charge free in return for receiving advertisements.

[Patent Document 1] Japanese Patent Application Laid-open No. 2001-111693

### SUMMARY OF THE INVENTION

The system disclosed in Patent Document 1 transmits an announcement to a calling party in accordance with a gender or an age of the calling party, or a calling time, or a calling place. However, in such a system, for example, in the case when the same calling party telephones some friends or the like at the same place in a similar period of time (for example, evening or the like), processing in which the calling party receives the same announcements is generated. That is, for the telephone of the calling party side, processing to receive uselessly overlapped information is generated. Further, in such a system, a wasteful communication packet increases in the system, and a circuit load in the system rises. Further, the telephone of the calling party side receiving the same announcements feels that such a service is disadvantage (for example, troublesome and so on) rather than advantage.

Further, the system disclosed in Patent Document 1 only extracts an advertisement close to an attribute of the calling party (a side receiving advertisements) as much as possible from among advertising contents ranging over various fields, which are applied randomly for advertisement. Thus, it is not always that an advertisement suitable for the side receiving advertisements is extracted, and accuracy related to advertisement extraction is low.

Further, since it is the advertisement in which its extraction accuracy is low as above, advertising transmission leads to a cause why the circuit load in the system is raised as the wasteful communication packet.

Further, in the system disclosed in Patent Document 1, the system selects an announcement uniformly to transmit it, and thereby an announcement whose credibility is low is provided easily. Accordingly, among the calling parties receiving announcements, there are some calling parties who do not feel like accessing providers providing announcements whose credibility is low even though they receive the announcements because their telephone charges become free in receiving the announcements. That is, for the providers providing the announcements as well, conventionally, it was only possible to transmit the announcements whose profitability is low, which are difficult to be accessed by the calling parties even when the providers transmit the announcements. As a result, the above contributes to the reason why such a service mode is not established.

The present invention is made in view of such problems, and an object of the present invention is to reduce the wasteful communication packet thereby suppressing a communication load and transmit an advertisement whose credibility is high, which is useful and in accordance with a recipient thereof.

Here, an information processing device of the present invention includes: a determination unit determining whether or not a telephone number of a called side included in a received telephone call control signal is registered in an advertising contract object that is stored in a memory unit and that includes a telephone number of an advertising contractant who performs a contract with an advertising provider and advertising provider identification information identifying the advertising provider with whom the advertising contractant performs the contract; an extraction unit extracting advertising data of the advertising provider identified by the advertising provider identification information corresponding to the telephone number of the called side from a memory unit when the telephone number of the called side is determined to be registered in the advertising contract object in the determination unit; and an advertising data transmission control unit transmitting the advertising data extracted in the extraction unit to a telephone apparatus identified by a telephone number of a calling side included in the telephone call control signal.

According to such a configurations the information processing device extracts an advertisement (or the advertising data) of the advertising provider with whom the called side contracts in accordance with the telephone number of the telephone apparatus of the called side included in the telephone call control signal received from the telephone apparatus of the calling side to transmit it to the calling side, and thereby, even in the case when, for example, the same calling party telephones some friends or the like at the same place in a similar period of time (for example, evening or the like), the calling party can receive different advertisements (or the advertising data). That is, according to such a configuration, the information processing device can reduce the wasteful communication packet thereby suppressing the communication load and transmit an advertisement whose credibility is high, which is useful and in accordance with a recipient thereof.

Note that the memory unit storing the advertising contract object corresponds to, for example, a HD 29 or a HD 19 or the like, which will be described later. Further, the advertising contract object corresponds to, for example, a later-described advertising contract information table, or a table corresponding to (a function) of the advertising contract information table, or a file corresponding to (the function) of the advertising contract information table, or the like. Further, the memory unit storing the advertising data corresponds to the HD 29, or the HD 19 or a content server, or the like, which will be described later.

Further, the present invention may be an advertising transmission method, a program product, and a system.

According to the present invention, it becomes possible to reduce the wasteful communication packet thereby suppressing the communication load and transmit an advertisement whose credibility is high, which is useful and in accordance with a recipient thereof.

### BRIEF DESCRIPTION OF THE DRAWINGS

FIG. 1 is a view showing one example of a system constitution;

FIG. 2 is a view showing one example of a hardware configuration of an information processing device 1;

FIG. 3 is a view showing one example of a hardware configuration of a DB server 2;

FIG. 4 is a view showing one example of a hardware configuration of a mobile phone apparatus such as a mobile phone apparatus 4 or a mobile phone apparatus 5;

FIG. 5 is a view (part 1) showing one example of an advertising contract information table 30;

FIG. 6 is a view showing one example of an advertising provider information table 40;

FIG. 7 is a view showing one example of a presence information table 50;

FIG. 8 is a view (part 1) showing one example of an advertising information table 60;

FIG. 9 is a view showing a functional configuration of one example of the information processing device 1;

FIG. 10 is a view showing a functional configuration of one example of the mobile phone apparatus 4;

FIG. 11 is a view showing a functional configuration of one example of the mobile phone apparatus 5;

FIG. 12 is a sequence diagram of one example of processing in a system;

FIG. 13 is a flowchart (part 1) of one example of processing from determination of an advertising contract of a called side based on a received telephone call control signal to transmission of advertising data in accordance with a calling side in the information processing device 1;

FIG. 14 is a view showing one example of a personal information table 70;

FIG. 15 is a view (part 2) showing one example of the advertising information table 60;

FIG. 16 is a flowchart (part 2) of one example of the processing from determination of the advertising contract of the called side based on the received telephone call control signal to transmission of the advertising data in accordance with the calling side in the information processing device 1;

FIG. 17 is a view (part 2) showing one example of the advertising contract information table 30;

FIG. 18 is a view (part 3) showing one example of the advertising contract information table 30;

FIG. 19 is a view (part 4) showing one example of the advertising contract information table 30;

FIG. 20 is a flowchart (part 3) of one example of the processing from determination of the advertising contract of the called side based on the received telephone call control signal to transmission of the advertising data in accordance with the calling side in the information processing device 1; and

FIG. 21 is a flowchart of one example of processing from determination of an advertising contract of a called side based on a received telephone call control signal to transmission of advertising data in accordance with a calling side and the called side in the information processing device 1.

### DETAILED DESCRIPTION OF THE PREFERRED EMBODIMENTS

Hereinafter, embodiments of the present invention will be explained based on the drawings.

### Embodiment 1

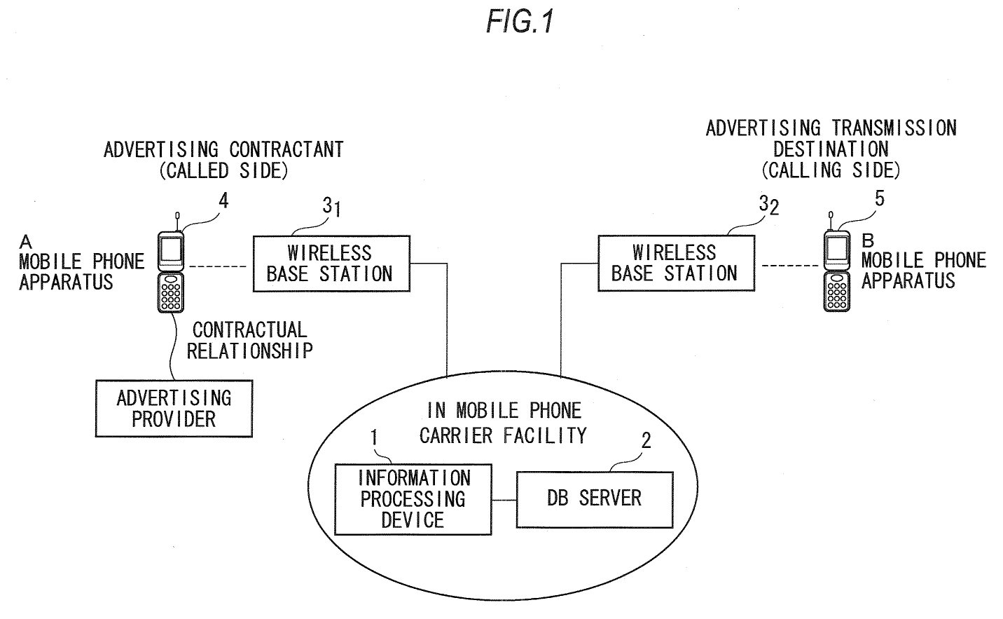

FIG. 1 is a view showing one example of the system constitution. As shown in FIG. 1, the system includes a plurality of wireless base stations 3, mobile phone apparatuses (in the example in FIG. 1, a mobile phone apparatus 4 and a mobile phone apparatus 5), which perform wireless communication with the nearby wireless base stations 3 and perform telephone communication and so on with each other via an information processing device 1 and so on in a mobile phone carrier facility, the information processing device 1, which is installed in the mobile phone carrier facility and performs processing with regard to transmission of advertising data as will be described later together with telephone exchange processing, and a DB server 2 storing information with regard to transmission of this advertising data, the advertising data, and so on.

Note that as shown in FIG. 1, an user A of the mobile phone apparatus 4 is set as an advertising contractant who establishes a contractual relationship with an advertising provider, and further, a called side. Further, an user B of the mobile phone apparatus 5 is set as a calling side, and further, an advertising transmission destination.

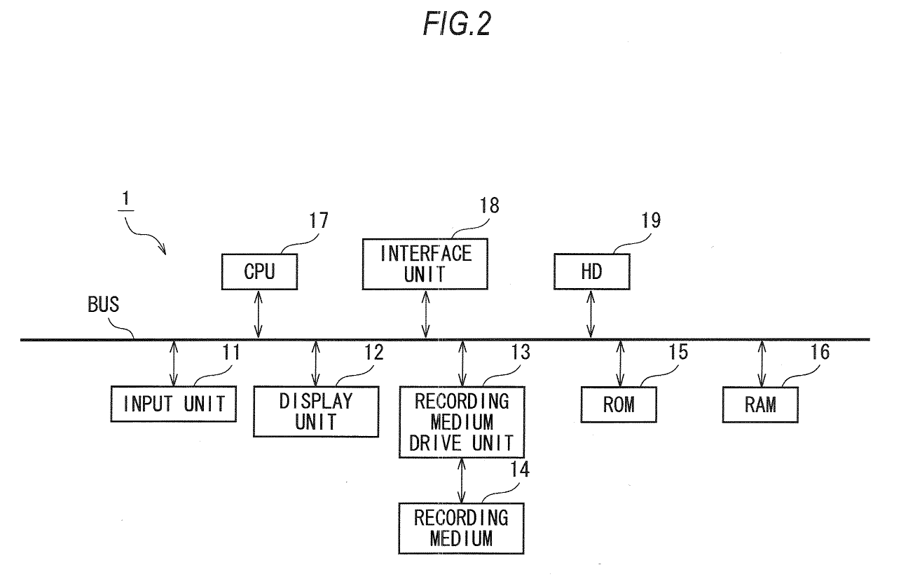

FIG. 2 is a view showing one example of the hardware configuration of the information processing device 1. As shown in FIG. 2, the information processing device 1 includes, as the hardware configuration, an input unit 11, a display unit 12, a recording medium drive unit 13, a ROM (Read Only Memory) 15, a RAM (Random Access Memory) 16, a CPU (Central Processing Unit) 17, an interface unit 18, and a HD (Hard Disk) 19.

The input unit 11 is composed of a keyboard, a mouse, and so on that an operator of the information processing device 1 operates and is used for inputting various kinds of operation information and so on to the information processing device 1. The display unit 12 is composed of a display and so on that the operator of the information processing device 1 uses and is used for displaying various kinds of information (or screens) and so on.

The interface unit 18 is a network connector connecting the information processing device 1 to a public network, the wireless base station 3, the DB server 2, and so on. Later-described functions with regard to transmission of the advertising data in the information processing device 1, or later-described programs related to a flowchart and so on with regard to transmission of the advertising data are provided to the information processing device 1 from a recording medium 14 such as, for example, a CD-ROM, or are downloaded through a network or the like. The recording medium 14 is set in the recording medium drive unit 13, and the programs are installed into the HD 19 from the recording medium 14 via the recording medium drive unit 13.

The ROM 15 records a program and so on first read at the time of power-on of the information processing device 1. The RAM 16 is a main memory of the information processing device 1. The CPU 17, when necessary, reads the program from the HD 19 to store the program in the RAM 16 and executes the program, thereby providing all or part of the later-described functions with regard to transmission of the advertising data and executing the later-described flowchart and so on with regard to transmission of the advertising data.

Note that the information processing device 1, as the hardware configuration, does not necessarily have to include the input unit 11, the display unit 12, and so on.

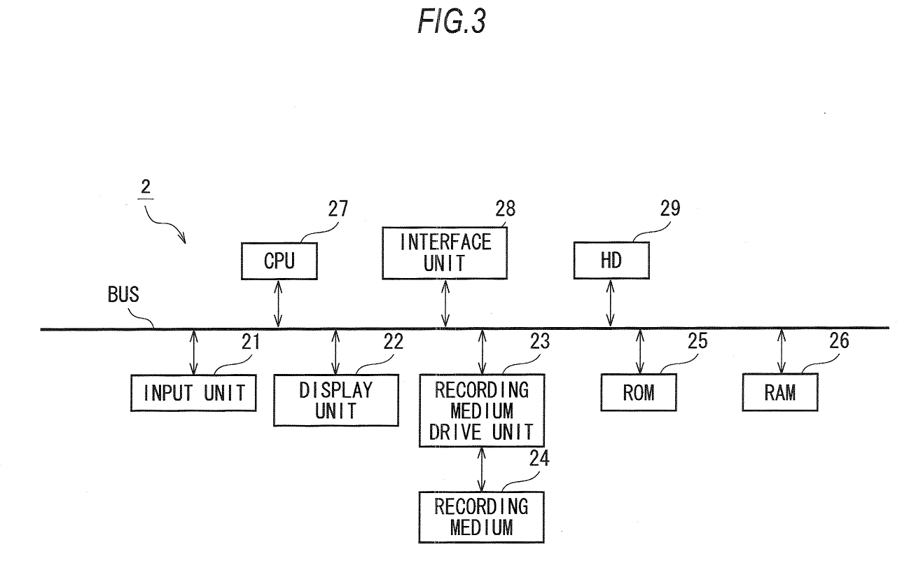

FIG. 3 is a view showing one example of the hardware configuration of the DB server 2. As shown in FIG. 3, the DB server 2, as the hardware configuration, includes an input unit 21, a display unit 22, a recording medium drive unit 23, a ROM 25, a RAM 26, a CPU 27, an interface unit 28, and a HD 29.

The input unit 21 is composed of a keyboard, a mouse, and so on that an operator of the DB server 2 operates and is used for inputting various kinds of operation information and so on to the DB server 2. The display unit 22 is composed of a display and so on that the operator of the DB server 2 uses and is used for displaying various kinds of information (or screens) and so on.

The interface unit 28 is a network connector connecting the DB server 2 to the information processing device 1 and so on. A program related to functions with regard to a DB operation is provided to the DB server 2 from a recording medium 24 such as, for example, a CD-ROM, or is downloaded through a network or the like. The recording medium 24 is set in the recording medium drive unit 23, and the program is installed into the HD 29 from the recording medium 24 via the recording medium drive unit 23.

The ROM 25 records a program and so on first read at the time of power-on of the DB server 2. The RAM 26 is a main memory of the DB server 2. The CPU 27, when necessary, reads the program from the HD 29 to store the program in the RAM 26 and executes the program, thereby providing all or part of the functions with regard to the DB operation.

Further, besides the program, the HD 29 stores each table that will be described later. Note that the DB server 2, as the hardware configuration, does not necessarily have to include the input unit 21, the display unit 22, and so on.

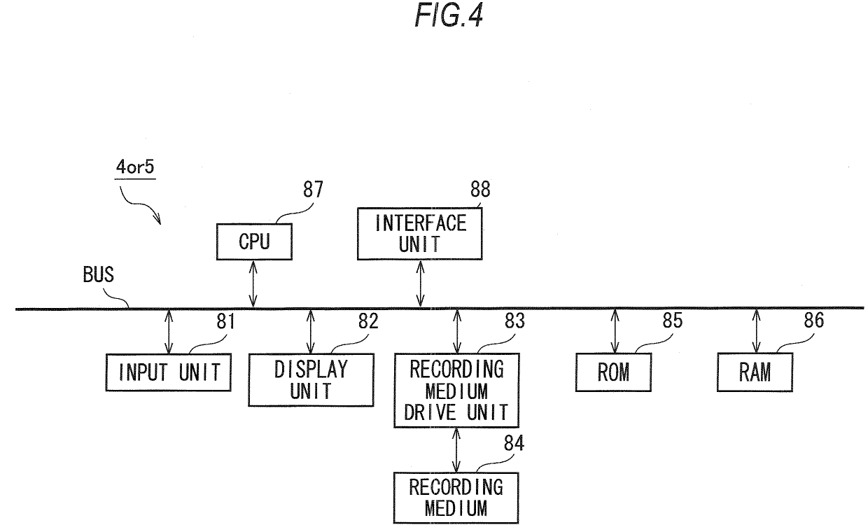

FIG. 4 is a view showing one example of the hardware configuration of the mobile phone apparatus such as the mobile phone apparatus 4 or the mobile phone apparatus 5. As shown in FIG. 4, the mobile phone apparatus, as the hardware configuration, includes an input unit 81, a display unit 82, a recording medium drive unit 83, a ROM 85, a RAM 86, a CPU 87, and an interface unit 88.

The input unit 81 is composed of buttons and so on that an operator (a user) of the mobile phone apparatus operates and is used for inputting various kinds of operation information and so on to the mobile phone apparatus. The display unit 82 is composed of a display and so on that the operator of the mobile phone apparatus uses and is used for displaying various kinds of information (or screens) and so on.

The interface unit 88 is a connector connecting the mobile phone apparatus to the wireless base station 3 and so on. A program related to functions of the mobile phone apparatus is provided to the mobile phone apparatus from, for example, a recording medium 84, or is downloaded through a network or the like. The recording medium 84 is set in the recording medium drive unit 83, and the program is installed into the RAM 86 and so on from the recording medium 84 via the recording medium drive unit 83.

The ROM 85 records a program and so on first read at the time of power-on of the mobile phone apparatus. The RAM 86 is a main memory of the mobile phone apparatus. The CPU 87 executes the program when necessary, thereby providing all or part of the later-described functions of the mobile phone apparatus.

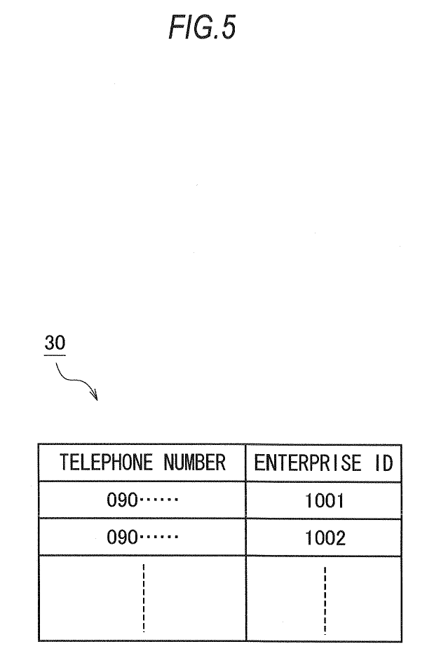

FIG. 5 is a view (part 1) showing one example of an advertising contract information table 30. The advertising contract information table 30, as shown in FIG. 5, includes a telephone number of the advertising contractant who performs a contract with the advertising provider and an enterprise ID identifying the advertising provider with whom the advertising contractant performs the contract. As will be described later, the advertising contract information table 30 is a table that is registered or changed, or the like in accordance with a request from the advertising contractant or the like. However, other tables that will be shown below are tables that are registered or changed, or the like in accordance with a request from the advertising provider or an operation of a manager of the system.

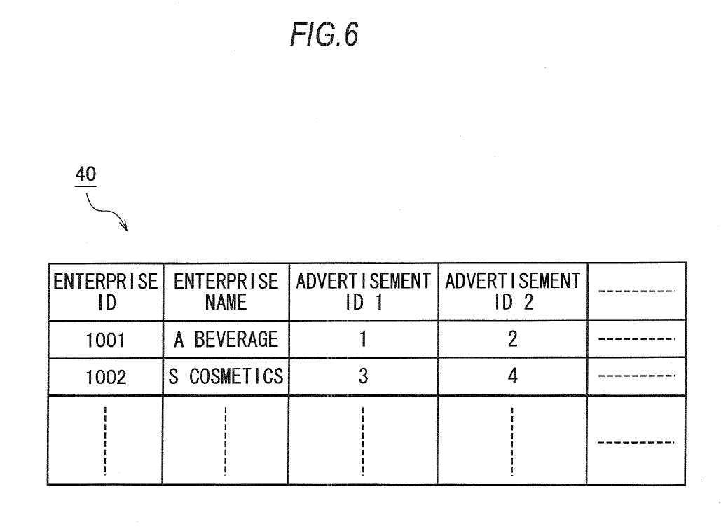

FIG. 6 is a view showing one example of an advertising provider information table 40. The advertising provider information table 40, as shown in FIG. 6, includes the enterprise ID identifying the advertising provider, an enterprise name of the advertising provider, and at least one or more advertisement IDs identifying advertisements that the advertising provider provides.

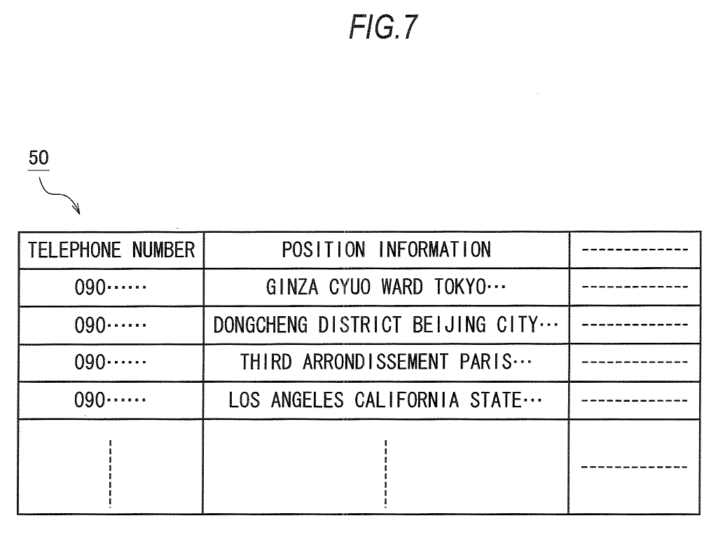

FIG. 7 is a view showing one example of a presence information table 50. The presence information table 50, as shown in FIG. 7, includes a telephone number identifying a subscriber to a mobile phone carrier and position information of the subscriber to the mobile phone carrier. Here, the DB server 2 may acquire the position information of the subscriber to the mobile phone carrier by using, for example, a GPS (Global Positioning System) function (an application) of the mobile phone apparatus 4 to store it in the presence information table 50. Further, the DB server 2 may have a position information calculation function (an application) and calculate the position information from location information or the like of the wireless base station 3 with which the mobile phone apparatus of the relevant telephone number performs communication by using this position information calculation function to store it in the presence information table 50.

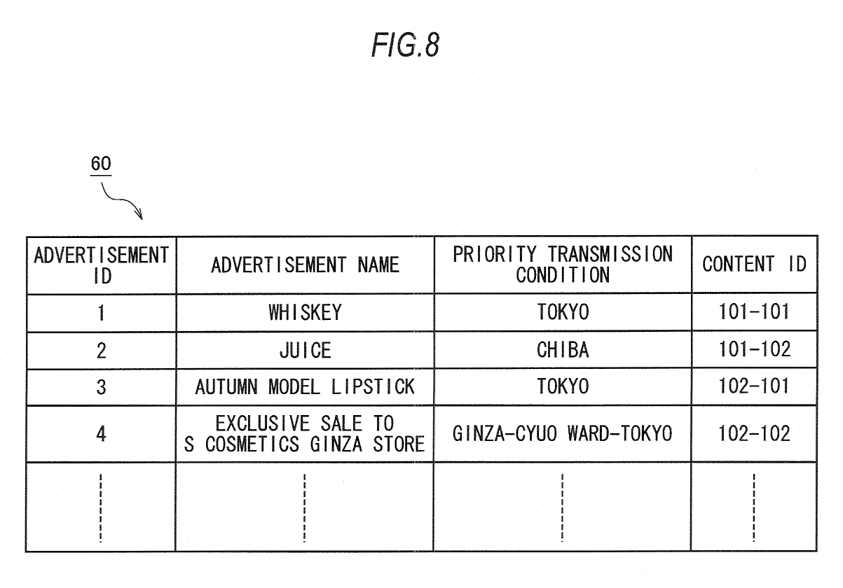

FIG. 8 is a view (part 1) showing one example of an advertising information table 60. The advertising information table 60 stores advertising information. The advertising information, as shown in FIG. 8, includes the advertisement ID identifying an advertisement, an advertisement name of the advertisement, a priority transmission condition of the advertisement, and a content ID identifying a content (data) of the advertisement.

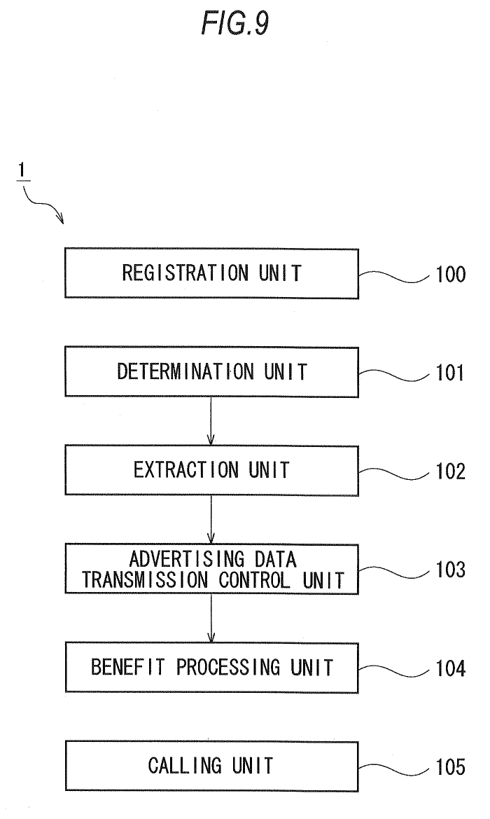

Hereinafter, there will be shown one example of the functional configuration of the information processing device 1, which is configured by the CPU 17, the RAM 16, the HD 19, the program, and so on, in FIG. 9. FIG. 9 is a view showing the functional configuration of one example of the information processing device 1. As shown in FIG. 9, the information processing device 1, as the functional configuration, includes a registration unit 100, a determination unit 101, an extraction unit 102, an advertising data transmission control unit 103, a benefit processing unit 104, and a calling unit 105.

When receiving contract request information from the mobile phone apparatus (for example, the mobile phone apparatus 4 or the like), the registration unit 100 registers the telephone number identifying the mobile phone apparatus and the enterprise ID identifying the advertising provider with whom the advertising contractant enters into the contract included in the contract request information in the advertising contract information table 30 in the DB server 2 in accordance with the contract request information. Further, the registration unit 100 may receive the contract request information from not only the mobile phone apparatus but also a browser of a PC or an interactive voice response apparatus, or the like.

For example, the user A of the mobile phone apparatus 4 contracts with S cosmetics being popular among friends. The registration unit 100 then registers the telephone number of the mobile phone apparatus 4 and the enterprise ID identifying S cosmetics in the advertising contract information table 30 in the DB server 2.

When receiving the telephone call control signal from the mobile phone apparatus of the calling side (for example, the mobile phone apparatus 5 or the like), the determination unit 101 determines whether or not the telephone number of the called side included in the telephone call control signal is registered in the advertising contract information table 30 in the DB server 2.

For example, the user B of the mobile phone apparatus 5 telephones the user A of the mobile phone apparatus 4. The determination unit 101 then determines whether or not the telephone number of the user A of the mobile phone apparatus 4 is registered in the advertising contract information table 30 in the DB server 2, that is, whether or not the user A of the mobile phone apparatus 4 performs the contract with the advertising provider with regard to advertising transmission.

When the telephone number of the called side included in the telephone call control signal is determined to be registered in the advertising contract information table 30 in the DB server 2 in the determination unit 101, the extraction unit 102 extracts the enterprise ID corresponding to the telephone number of the called side from the advertising contract information table 30 in the DB server 2. Then, the extraction unit 102 extracts the advertisement ID corresponding to the enterprise ID from the advertising provider information table 40 in the DB server 2 by using this enterprise ID.

Further, the extraction unit 102 extracts the position information corresponding to the telephone number of the calling side from the presence information table 50 in the DB server 2. Note that in this embodiment, there is given an explanation to the effect that the extraction unit 102 extracts the position information corresponding to the telephone number of the calling side from the presence information table 50 in the DB server 2. However, it may be configured so that the extraction unit 102 has the GPS function (the application) or the position information calculation function (the application) as described above directly to acquire the position information corresponding to the telephone number of the calling side.

The extraction unit 102 extracts the content ID corresponding to the advertisement ID and the position information, which are extracted, from the advertising information table 60 in the DB server 2, and extracts (or acquires) the content (the advertising data) corresponding to this content ID from, for example, a content server (not shown).

For example, the extraction unit 102 extracts the advertising data of Ginza store of S cosmetics in the case when the advertisement ID extracted from the advertising provider information table 40 is “3” and “4”, and the position information extracted from the presence information table 50 is “ . . . Ginza Chuo ward Tokyo”. Note that in this embodiment, the advertising data is set as images (still images or moving images).

The advertising data transmission control unit 103 transmits the advertising data extracted in the extraction unit 102 to the mobile phone apparatus of the calling side (for example, the mobile phone apparatus 5 or the like). Note that the advertising data transmission control unit 103 may transmit the advertising data to the mobile phone apparatus of the calling side while calling the called side, or transmit the advertising data to the mobile phone apparatus of the calling side while performing telephone communication, or transmit the advertising data to the mobile phone apparatus of the calling side after telephone communication ends.

Note that the timing of transmitting the advertising data may be predetermined. Further, the advertising contractant (or the information processing device 1 that receives a request from the advertising contractant) may be able to set the timing of transmitting the advertising data in each advertising provider enterprise with whom the advertising contractant contracts in the advertising contract information table 30. Then, the advertising data transmission control unit 103 may transmit the advertising data based on this set timing. Further, the advertising provider enterprise (or the information processing device 1 that receives a request from the advertising provider enterprise) may be able to set the timing of transmitting the advertising data in each advertisement in the advertising provider information table 40. Then, the advertising data transmission control unit 103 may transmit the advertising data based on this set timing.

The benefit processing unit 104 performs processing with regard to benefits accompanying transmission of the advertising data of the advertising provider enterprise with whom the advertising contractant contracts such as for example, processing to make a telephone charge of the advertising contractant related to transmission of the advertising data free, or processing to add points in accordance with the number of transmitted advertising data.

The calling unit 105 has an equivalent function to call control at a general telephone exchange, and calls a telephone apparatus of the called side.

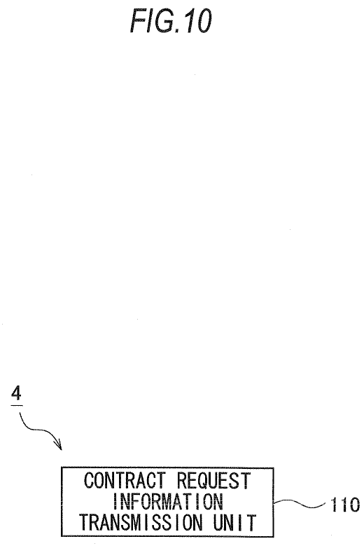

Hereinafter, there will be shown one example of the functional configuration of the mobile phone apparatus 4 configured by the CPU, the RAM, the program, and so on in the mobile phone apparatus 4 in FIG. 10. FIG. 10 is a view showing the functional configuration of one example of the mobile phone apparatus 4. As shown in FIG. 10, the mobile phone apparatus 4, as the functional configuration, includes a contract request information transmission unit 110.

The contract request information transmission unit 110 transmits the contract request information to the information processing device 1 in accordance with an operation of a user A or the like.

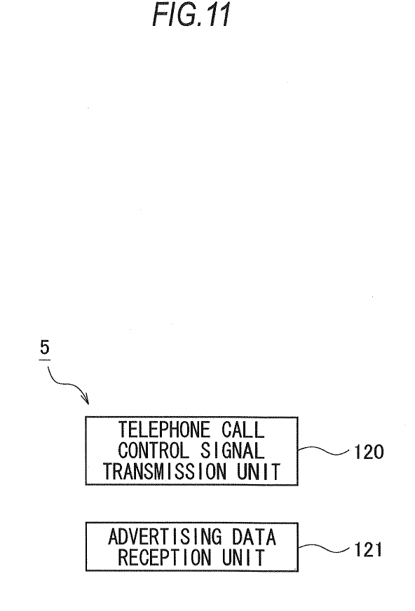

Next, there will be shown one example of the functional configuration of the mobile phone apparatus 5 configured by the CPU, the RAM, the program, and so on in the mobile phone apparatus 5 in FIG. 11. FIG. 11 is a view showing the functional configuration of one example of the mobile phone apparatus 5. As shown in FIG. 11, the mobile phone apparatus 5, as the functional configuration, includes a telephone call control signal transmission unit 120 and an advertising data reception unit 121.

The telephone call control signal transmission unit 120 transmits the telephone call control signal to the information processing device 1 in accordance with an operation of a user B or the like. The advertising data reception unit 121 receives the advertising data transmitted from the information processing device 1.

Note that in this embodiment, to simplify explanation, the functional configurations of the mobile phone apparatus 4 and the mobile phone apparatus 5 are explained separately in FIG. 4 and FIG. 5, but the functional configuration of each mobile phone apparatus is basically the same. That is, it is set that the mobile phone apparatus 4 and the mobile phone apparatus 5 have the functions shown in FIG. 10 and FIG. 11.

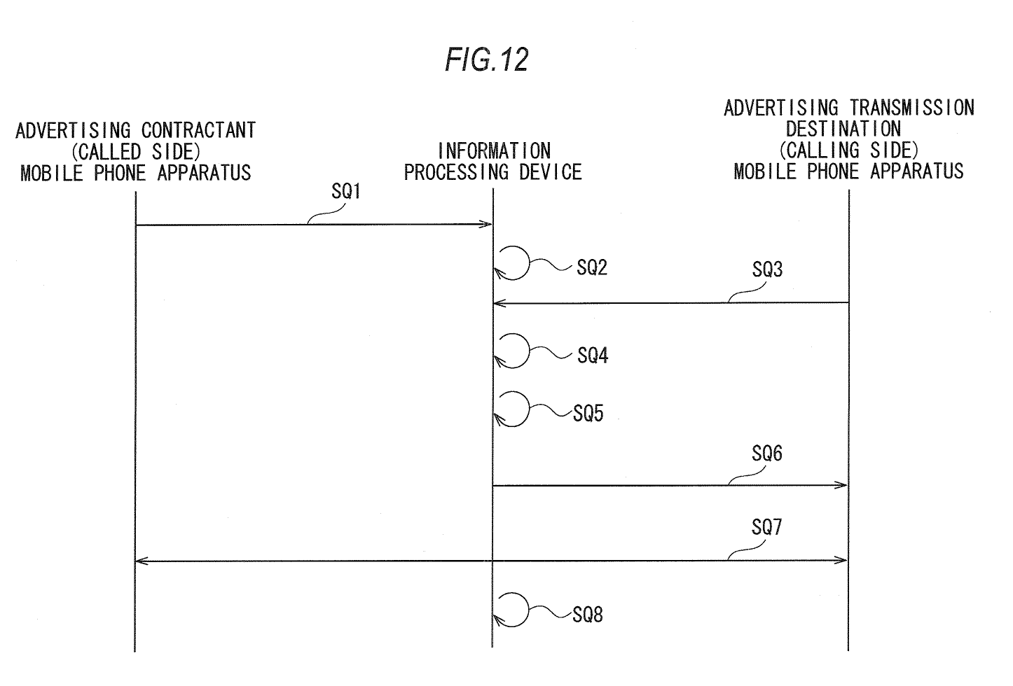

FIG. 12 is a sequence diagram of one example of processing in the system. Note that in FIG. 12, to simplify explanation, the wireless base station 3, the DB server 2, and so on are omitted.

At Sequence SQ1, the mobile phone apparatus 4 transmits the contract request information to the information processing device 1 in accordance with the operation of the user A or the like.

At Sequence SQ2, the registration unit 100 in the information processing device 1 registers the telephone number identifying the mobile phone apparatus 4 and the enterprise ID identifying the advertising provider with whom the user A of the mobile phone apparatus 4 enters into the contract included in the contract request information in the advertising contract information table 30 in the DB server 2 in accordance with the contract request information received from the mobile phone apparatus 4.

On the other hand, at Sequence SQ3, the mobile phone apparatus 5 transmits the telephone call control signal to the information processing device 1 in accordance with the operation of the user B or the like.

At Sequence SQ4, the determination unit 101 in the information processing device 1 determines whether or not the telephone number of the called side (for example, the telephone number of the mobile phone apparatus 4) included in the telephone call control signal is registered in the advertising contract information table 30 in the DB server 2 in accordance with the telephone call control signal received from the mobile phone apparatus 5.

At Sequence SQ4, when the telephone number of the called side included in the telephone call control signal is determined to be registered in the advertising contract information table 30 in the DB server 2, at Sequence SQ5, the extraction unit 102 in the information processing device 1 extracts the enterprise ID corresponding to the telephone number of the called side from the advertising contract information table 30 in the DB server 2. Then, the extraction unit 102 extracts the advertisement ID corresponding to the enterprise ID from the advertising provider information table 40 in the DB server 2 by using this enterprise ID.

Further, the extraction unit 102 extracts the position information corresponding to the telephone number of the calling side from the presence information table 50 in the DB server 2. Then, the extraction unit 102 extracts the content ID corresponding to the advertisement ID and the position information, which are extracted, from the advertising information table 60 in the DB server 2, and extracts (or acquires) the content (the advertising data) corresponding to this content ID from, for example, the content server (not shown).

At Sequence SQ6, the advertising data transmission control unit 103 in the information processing device 1 transmits the advertising data extracted at Sequence SQ5 to the mobile phone apparatus 5.

At Sequence SQ7, the calling unit 105 in the information processing device 1 calls the mobile phone apparatus 4 of the called side and connects a call between the mobile phone apparatus 5 and the mobile phone apparatus 4. Note that as described above, transmission of the advertising data may be performed after telephone communication or while performing telephone communication, and in the case when it is performed after telephone communication, for example, the processing at Sequence SQ6 is performed after Sequence SQ7, and in the case when it is performed while performing telephone communication, for example, the processing at Sequence SQ6 and Sequence SQ7 are performed simultaneously.

At Sequence SQ8, the benefit processing unit 104 in the information processing device 1 performs, for example, the processing to make the telephone charge of the advertising contractant related to transmission of the advertising data free, or the processing to add points in accordance with the number of transmitted advertising data and so on, or the like.

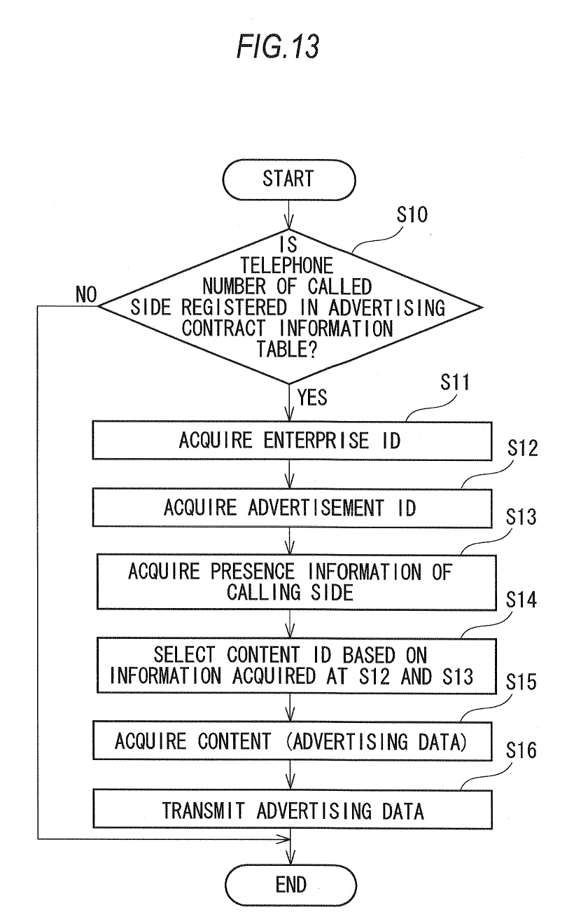

FIG. 13 is a flowchart (part 1) of one example of processing from determination of the advertising contract of the called side based on the received telephone call control signal to transmission of the advertising data in accordance with the calling side in the information processing device 1. That is, in FIG. 13, there will be explained one example of the processing in the information processing device 1 from Sequence SQ4 to Sequence SQ6 in FIG. 12.

At Step S10, the determination unit 101 determines whether or not the telephone number of the called side (for example, the telephone number of the mobile phone apparatus 4) included in the telephone call control signal is registered in the advertising contract information table 30 in the DB server 2 in accordance with the telephone call control signal received from the mobile phone apparatus 5 being the calling side. The determination unit 101 proceeds to Step S11 when determining that the telephone number of the called side is registered in the advertising contract information table 30 in the DB server 2 (YES at Step S10), whereas the determination unit 101 ends the processing shown in FIG. 13 when determining that the telephone number of the called side is not registered in the advertising contract information table 30 in the DB server 2 (NO at Step S10).

At Step S11, the extraction unit 102 extracts the enterprise ID corresponding to the telephone number of the called side from the advertising contract information table 30 in the DB server 2.

Subsequently, at Step S12, the extraction unit 102 extracts the advertisement ID corresponding to the enterprise ID from the advertising provider information table 40 in the DB server 2 by using the enterprise ID extracted at Step S11.

At Step S13, the extraction unit 102 extracts the position information corresponding to the telephone number of the calling side from the presence information table 50 in the DB server 2 based on the telephone number of the calling side. Note that the processing at Step S13 may be performed before Step S11, or performed simultaneously with the processing at Step S11 or Step S12.

At Step S14, the extraction unit 102 selects the advertisement (the content ID) identified by the advertisement ID acquired at Step S12 from the advertising information table 60 in the DB server 2. In the case when this content ID exists plurally, the extraction unit 102 compares the priority transmission condition corresponding to each of the content IDs and the position information acquired at Step S13, and selects (extracts) the content ID of the priority transmission condition more matching the position information of the calling side. To explain more concretely, based on the priority transmission condition (the position information in this embodiment) corresponding to each of the content IDs and the position information acquired at Step S13, the extraction unit 102 calculates the distances there between, by making use of the GPS function and selects the content ID of the priority transmission condition of the closest distance.

Subsequently, at Step S15, the extraction unit 102 acquires the content (the advertising data) corresponding to the content ID extracted at Step S14 from, for example, the content server (not shown).

Subsequently, at Step S16, the advertising data transmission control unit 103 transmits the advertising data extracted at Step S15 to the mobile phone apparatus 5 being the calling side.

According to this embodiment as described above, since it is possible to transmit the proper advertising data more suitable for the recipient attribute from the credible person (the advertising contractant) to the advertising recipient, a wasteful communication packet can be reduced and a communication load can be suppressed. Further, for the advertising provider, it is possible to increase a possibility leading to a profit. Further, according to this embodiment, the advertising contractant (the called side) can obtain a benefit in which the telephone charge becomes free or points are added, and thereby, for example, a service according to the points can be received, or the like. On the other hand, the advertising transmission destination (the calling side) can receive the advertising data of, for example, a current article and so on from the credible called side.

Note that in the above-described example, there is explained the example in which the extraction unit 102 calculates the distances by using the GPS function to select the content ID of the priority transmission condition of the closest distance to the position information (or the presence information) acquired at Step S13. However, the extraction unit 102 may perform for example, a thesaurus search, a partial match search, or a rule based engine search, or the like in accordance with information with regard to the calling side such as, for example, the acquired presence information, and select (extract) the content ID of the priority transmission condition more matching the information with regard to the calling side. According to this manner, even in the case when the information with regard to the calling side as will be described later and the priority transmission condition are except the position information, the proper content ID can be selected. Thus, since it is possible to extract the proper advertising data more suitable for the attribute of the advertising recipient and transmit it, the wasteful communication packet can be reduced and the communication load can be suppressed.

Further, a table where information with regard to a transmission history of the transmitted advertising data is managed and so on may be stored in the DB server 2. According to this manner, in the case when the advertising data is meaningless depending on the content of the advertising data even if the recipient receives the advertising data in an overlapped manner, the information processing device 1 can prevent the sama advertising data from being transmitted repeatedly to the advertising recipient, and thereby the wasteful communication packet can be reduced and the communication load can be suppressed. Further, by managing the information with regard to the transmission history of the advertising data as above, in the case when the advertising data is in serial form, a sequence of flows of the advertising data can be held, and therefore, the information processing device 1 can similarly reduce the wasteful communication packet and suppress the communication load.

### Embodiment 2

In the above-described Embodiment 1, as shown in FIG. 8, only the position information of the advertising transmission destination (the calling side) is set as the priority transmission condition. However, time information, air temperature information, weather information, age information, gender information, or period information (for example, from September to November, or the like) or a combination of these pieces of information may be set as the priority transmission condition.

Note that in this embodiment, there will be mainly explained a point different from the above-described embodiment. The same applies to the following embodiments.

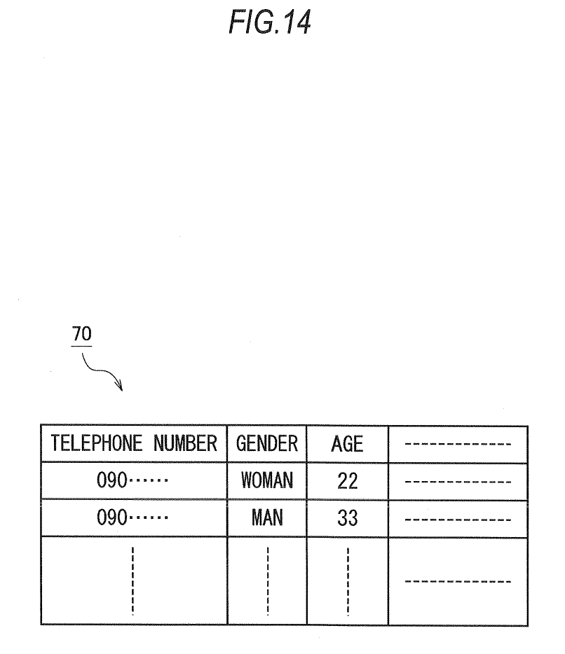

FIG. 14 is a view showing one example of a personal information table 70. The DB server 2 in this embodiment has the personal information table 70 shown in FIG. 14 held in the HD 29 in addition to each of the tables shown in the above-described Embodiment 1. The personal information table 70, as shown in FIG. 14, includes a telephone number of a subscriber to a mobile phone carrier, a gender of the subscriber, and an age of the subscriber.

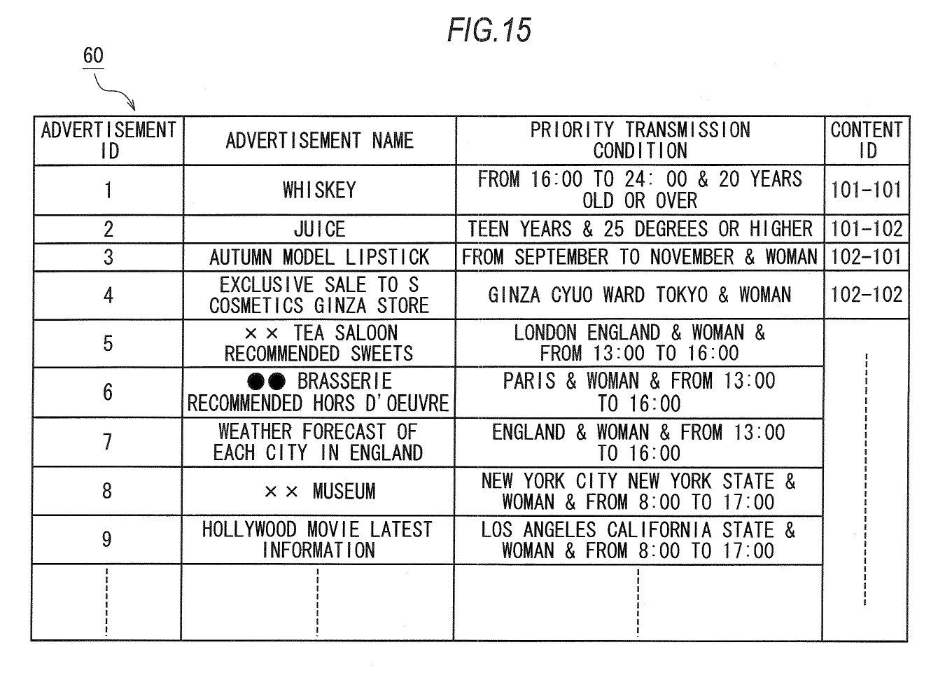

FIG. 15 is a view (part 2) showing one example of the advertising information table 60. In the advertising information table 60 in this embodiment, as the priority transmission condition, a combination of the time information, the air temperature information, the age information, the gender information, and the period information (for example, from September to November, or the like) is set.

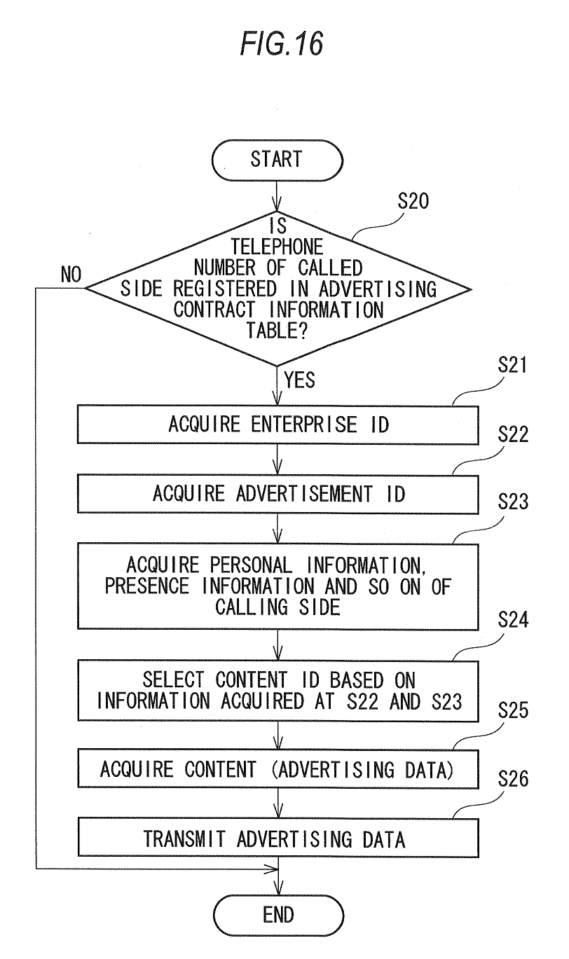

FIG. 16 is a flowchart (part 2) of one example of the processing from determination of the advertising contract of the called side based on the received telephone call control signal to transmission of the advertising data in accordance with the calling side in the information processing device 1. Note that the processing from Step S20 to Step S22 are the same as the processing from Step S10 to Step S12 in FIG. 13 in Embodiment 1, and therefore explanation thereof is omitted.

At Step S23, the extraction unit 102 in this embodiment (hereinafter, simply called the extraction unit 102) extracts the position information corresponding to the telephone number of the calling side from the presence information table 50 in the DB server 2 based on the telephone number of the calling side. Further, the extraction unit 102 extracts personal information such as a gender, an age corresponding to the telephone number of the calling side from the personal information table 70 in the DB server 2 based on the telephone number of the calling side. Further, the extraction unit 102 passes the extracted position information to a meteorological information provision server (not shown), or the like to acquire meteorological information, the weather information, and so on of the calling side. Further, the extraction unit 102 may acquire the time information of the calling side from a timer or the like that the information processing device 1 has as a function. That is, at Step S23, the extraction unit 102 extracts or acquires the information with regard to the calling side.

At Step S24, the extraction unit 102 selects the advertisement (the content ID) identified by the advertisement ID acquired at Step S22 from the advertising information table 60 in the DB server 2. In the case when this content ID exists plurally, the extraction unit 102 compares the priority transmission condition corresponding to each of the content IDs and the information with regard to the calling side such as the position information, the personal information, the meteorological information, the weather information, and the time information, each of which is acquired at Step S23, and selects (extracts) the content ID of the priority transmission condition more matching the information with regard to the calling side.

Note that in the comparison processing in the extraction unit 102 at Step S24, the thesaurus search, the partial match search, the rule based engine search, or the like, which is described above, is performed to select (extract) the content ID of the priority transmission condition more matching the information with regard to the calling side that the extraction unit 102 extracts at Step S23.

Note that the processing at Step S25 and Step S26 are the same as the processing at Step S15 and Step S16 in FIG. 13 in Embodiment 1, and therefore explanation thereof is omitted.

According to this embodiment as described above, it becomes possible to determine the advertising data to be transmitted in accordance with the various information with regard to the calling side such as the time information, the air temperature information, the weather information, the gender information, and the age information in addition to the position information and to acquire it. Thus, the advertising provider can send the advertisement (or the advertising data) more suitable for the calling side from among the advertisements of various pieces of merchandise that the advertising provider has. Accordingly, since the proper advertising data more suitable for the attribute of the advertising recipient can be transmitted, the wasteful communication packet can be reduced and the communication load can be suppressed.

According to this embodiment, for example, the information processing device 1 can perform processing to transmit the advertising data of whiskey to the calling side in the case when the time when the calling side calls the advertising contractant (the called side) is between 16:00 and 24:00, and the age of the calling side is 20 years old or over, or to transmit the advertising data of juice to the calling side in the case when the age of the calling side is teen years, and the air temperature of the calling side is 25 degrees or higher, or the like.

Further, according to this embodiment, even in the case when the user of the mobile phone apparatus on the calling side and the user of the mobile phone apparatus on the called side are not in the same country and, for example, a time difference is generated, the information processing device 1 extracts the information with regard to the side receiving the advertisement (the calling side) in accordance with the telephone call control signal. Then, the information processing device 1 can perform processing to select the advertising data matching the calling side based on the extracted information with regard to the side receiving the advertisement, and to transmit it to the calling side, and the like. For example, in the case when the user (a woman) of the mobile phone apparatus on the calling side, who is in London in England, calls the advertising contractant (the user of the mobile phone apparatus on the called side), who is in third arrondissement in Paris, at 15:00, Jan. 1, 2007, which is the time of the calling side (at 16:00, Jan. 1, 2007, which is the time of the called side in third arrondissement in Paris), the information processing device 1 can transmit the advertising data with regard to recommended sweets of XX tea saloon where is located in London to the calling side. Further, the extraction unit 102, as explained previously, may select (extract) the content ID of the priority transmission condition more matching the information with regard to the calling side by performing, for example, the thesaurus search or the like. Accordingly, in the case when the information that the user of the mobile phone apparatus on the calling side who is in England is in London in the above example is not acquired, the information processing device 1 can transmit the advertising data with regard to a weather forecast of this day afternoon in each city of England to the calling side.

Further, according to this embodiment, even in the case when the user of the mobile phone apparatus on the calling side and the user of the mobile phone apparatus on the called side are in the same country, depending on a country, there is a case that, for example a time difference is generated. Even in this case, the information processing device 1 similarly can perform the processing to extract the information with regard to the side receiving the advertisement (the calling side) and select the advertising data matching the calling side based on the extracted information with regard to the side receiving the advertisement to transmit it to the calling side, and the like. For example, in the case when the user (a woman) of the mobile phone apparatus on the calling side who is in New York city, N.Y. State, United States, calls the advertising contactant (the user of the mobile phone apparatus on the called side), who is in Los Angeles, Calif. State, United States at 12:00, Jan. 1, 2007, which is the time of the calling side (at 9:00, Jan. 1, 2007, which is the time of the called side in Los Angeles), the information processing device 1 can transmit the advertising data with regard to an admission ticket discount coupon of X X museum located in New York to the calling side.

Note that this embodiment (and the above-described Embodiment 1) are explained with the example in which only the position information of the subscriber to the mobile phone carrier is included in the presence information table 50. However, mood information of the subscriber to the mobile phone carrier and information of a place where the subscriber to the mobile phone carrier is located now (for example, a station, an air port, a vehicle, a restaurant, and so on) may be allowed to be registered in the presence information table 50. These pieces of information may be registered (or updated) by the subscriber to the mobile phone carrier operating the mobile phone apparatus, or the like, or registered (or updated) automatically by a system.

Then, these pieces of information, namely the mood information and the place information may be set in the priority transmission condition of the advertising information table 60 as well. According to this manner, advertising transmission of which a target is further narrowed down can be performed.

### Embodiment 3

The above-described embodiments are explained on the assumption that the advertising data is the images (the still images or the moving images). However, the advertising data may be, for example, sound. In the case of sound, the information processing device 1 can carry (or transmit) sound such as, for example, “◯◯ supermarket, all frozen food half price sale takes place from 16:00” instead of ringing a tone when the calling side calls the advertising contractant (the called side).

### Embodiment 4

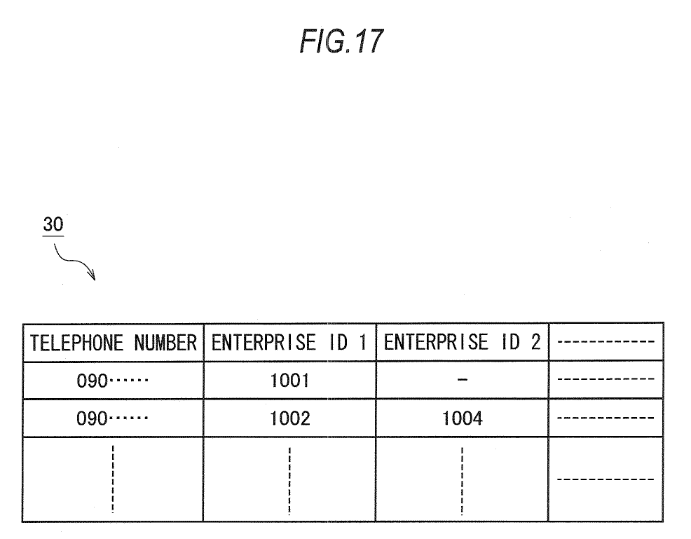

In the above-described embodiments, as shown in FIG. 5, there is given the explanation to the effect that the advertising contractant performs the contract with the single advertising provider. However, as shown in FIG. 17, the advertising contractant may perform the contract with the plurality of advertising providers. Such an example will be explained in this embodiment. FIG. 17 is a view (part 2) showing one example of the advertising contract information table 30.

In the case when the advertising contract information table 30 is constituted in this manner, the extraction unit 102 extracts at least one or more enterprise IDs corresponding to the telephone number of the called side from the advertising contract information table 30 in the DB server 2 at, for example, Step S21 in FIG. 16 in Embodiment 2 (here, it is set that, for example, the plural enterprise IDs are extracted).

Subsequently, at Step S22, the extraction unit 102 in this embodiment extracts the plural advertisement IDs corresponding to the enterprise TDs from the advertising provider information table 40 in the DB server 2 by using the plural enterprise IDs extracted at Step S21. Note that the processing after Step S23 are the same as the processing explained in the above-described embodiment, and therefore explanation thereof is omitted.

According to this embodiment, the information processing device 1 can select the advertisement (the advertising data) of the priority transmission condition more matching the information with regard to the calling side from among the plural advertisements of the plural advertising providers with whom the advertising contractant performs the contract to transmit it.

### Embodiment 5

The above-described Embodiment 4, as shown in FIG. 17, explains the example where the advertising contractant performs the contract with the plural advertising providers. In this embodiment, there will be explained an example in which priority is set for each advertising provider in the case when the advertising contractant performs the contract with the plural advertising providers.

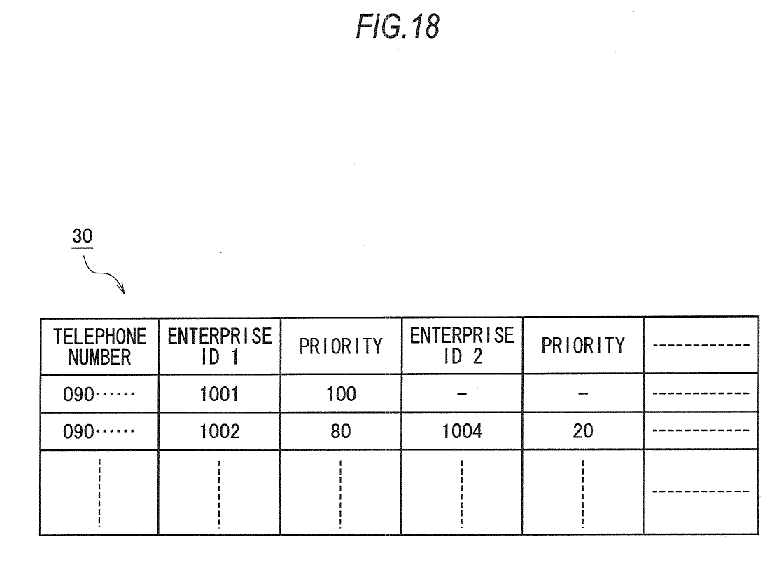

FIG. 18 is a view (part 3) showing one example of the advertising contract information table 30. As shown in FIG. 18, the advertising contract information table 30 in this embodiment includes priority. When receiving priority setting information from the mobile phone apparatus of the advertising contractant or the like, the information processing device 1 sets priority that the advertising contractant instructs for each enterprise ID of the relevant advertising contract information in the advertising contract information table 30 shown in FIG. 18 in accordance with this priority setting information.

In the case when the advertising contract information table 30 is constituted in this manner, the extraction unit 102 extracts the enterprise ID corresponding to the telephone number of the called side from the advertising contract information table 30 in the DB server 2 in accordance with priority at, for example, Step S21 in FIG. 16 in Embodiment 2.

The extraction unit 102 in this embodiment extracts, for example, an enterprise ID 1 “1002” and an enterprise ID 2 “1004” in the proportion of four to one. That is, the advertisement of the enterprise ID 1 “1002” is transmitted to the calling side four times, whereas the advertisement of the enterprise ID 2 “1004” is transmitted to the calling side once. Note that the order in which the extraction unit 102 extracts the enterprise ID 1 “1002” and the enterprise ID 2 “1004” may be arbitrary.

According to this embodiment, the information processing device 1 can select (or determine) the advertising provider from among the plural advertising providers with whom the advertising contractant performs the contract in accordance with the proportion that the advertising contractant sets to transmit the advertisement of this advertising provider to the calling side.

### Embodiment 6

The above-described Embodiment 5, as shown in FIG. 18, explains the example where priority is set for each advertising provider in the case when the advertising contractant performs the contract with the plural advertising providers. In this embodiment, there will be explained an example in which the priority transmission condition is set for each advertising provider in the case when the advertising contractant performs the contract with the plural advertising providers.

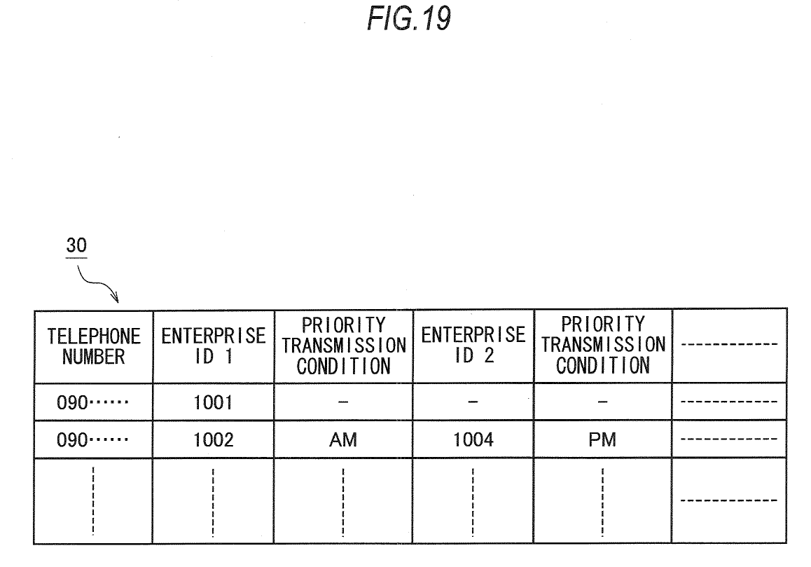

FIG. 19 is a view (part 4) showing one example of the advertising contract information table 30. As shown in FIG. 19, the advertising contract information table 30 in this embodiment includes the priority transmission condition. When receiving priority transmission condition setting information from the mobile phone apparatus of the advertising contractant or the like, the information processing device 1 sets the priority transmission condition that the advertising contractant instructs for each enterprise ID of the relevant advertising contract information in the advertising contract information table 30 shown in FIG. 19 in accordance with this priority transmission condition setting information.

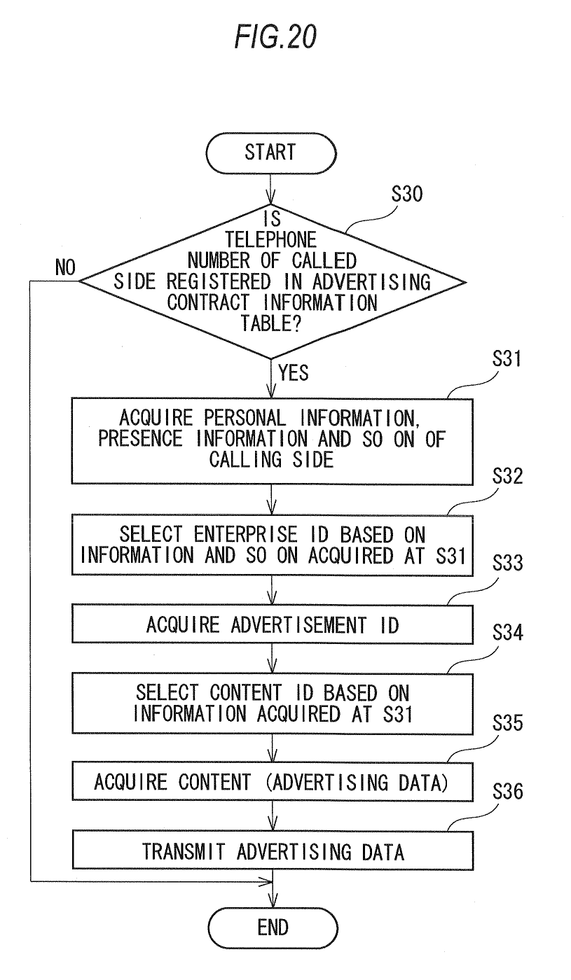

FIG. 20 is a flowchart (part 3) of one example of the processing from determination of the advertising contract of the called side based on the received telephone call control signal to transmission of the advertising data in accordance with the calling side in the information processing device 1.

At Step S30, the determination unit 101 determines whether or not the telephone number (for example, the telephone number of the mobile phone apparatus 4) of the called side included in the telephone call control signal is registered in the advertising contract information table 30 in the DB server 2 in accordance with the telephone call control signal received from the mobile phone apparatus 5 being the calling side. The determination unit 101 proceeds to Step S31 when determining that the telephone number of the called side is registered in the advertising contract information table 30 in the DB server 2 (YES at Step S30), whereas the determination unit 101 ends the processing shown in FIG. 20 when determining that the telephone number of the called side is not registered in the advertising contract information table 30 in the DB server 2 (NO at Step S30).

At Step S31, the extraction unit 102 in this embodiment (hereinafter, simply called the extraction unit 102) extracts the position information corresponding to the telephone number of the calling side from the presence information table 50 in the DB server 2 based on the telephone number of the calling side. Further, the extraction unit 102 extracts the personal information such as the gender, the age, and so on corresponding to the telephone number of the calling side from the personal information table 70 in the DB server 2 based on the telephone number of the calling side. Further, the extraction unit 102 passes the extracted position information to the meteorological information provision server (not shown) or the like to acquire the meteorological information, the weather information, and so on of the calling side. Further, the extraction unit 102 may acquire the time information of the calling side from the timer or the like that the information processing device 1 has as the function. That is, at Step S31, the extraction unit 102 extracts or acquires the information with regard to the calling side.

At Step S32, the extraction unit 102 selects the enterprise ID corresponding to the telephone number of the called side from the advertising contract information table 30 in the DB server 2. In the case when this enterprise ID exists plurally, the extraction unit 102 compares the priority transmission condition corresponding to each of the enterprise IDs and the information with regard to the calling side such as the position information, the personal information, the meteorological information, the weather information, and the time information, each of which is acquired at Step S31, to select (extract) the enterprise ID of the priority transmission condition more matching the information with regard to the calling side.

Subsequently, at Step S33, the extraction unit 102 extracts the advertisement ID corresponding to the enterprise ID from the advertising provider information table 40 in the DB server 2 by using the enterprise ID extracted at Step S32.

At Step S34, the extraction unit 102 selects the advertisement (the content ID) identified by the advertisement ID acquired at Step S33 from the advertising information table 60 in the DB server 2. In the case when this content ID exists plurally, the extraction unit 102 compares the priority transmission condition corresponding to each of the content IDs and the information with regard to the calling side such as the position information, the personal information, the meteorological information, the weather information, and the time information, each of which is acquired at Step S31, to select (extract) the content ID of the priority transmission condition more matching the information with regard to the calling side. Note that the comparison processing at Step S32 and Step S34 are the same as the above-described comparison processing, and therefore explanation thereof is omitted. Note that the processing at Step S35 and Step S36 are the same as the processing at Step S15 and Step S16 in FIG. 13 in Embodiment 1, and therefore explanation thereof is omitted.

According to this embodiment as described above, in the case when the advertising contractant performs the contract with the plural advertising providers, the priority transmission condition can be set for each advertising provider. Note that although this embodiment explains the example where the advertising contractant sets the priority transmission condition for each advertising provider in combination with the above-described Embodiment 2, this does not limit to this embodiment, and this embodiment may be performed in combination with, for example, the above-described Embodiment 1.

### Embodiment 7

The above-described embodiments explain the example where the advertising data is transmitted to only the calling side. There will be explained an example in which the advertising data is also transmitted to the called side (the advertising contractant) in this embodiment.

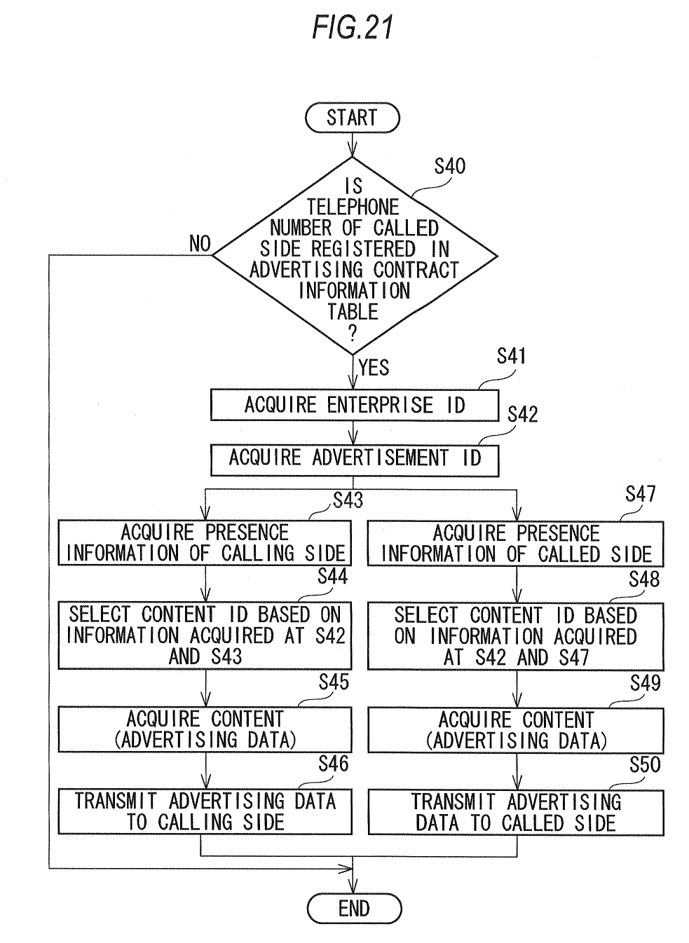

FIG. 21 is a flowchart of one example of processing from determination of the advertising contract of the called side based on the received telephone call control signal to transmission of the advertising data in accordance with the calling side and the called side in the information processing device 1. Note that the processing from Step S40 to Step S42 are the same as the processing from Step S10 to Step S12 in FIG. 13 in Embodiment 1, and therefore explanation thereof is omitted. Further, the processing from Step S43 to Step S46 are the same as the processing from Step S13 to Step S16 in FIG. 13 in Embodiment 1, and therefore explanation thereof is omitted.

At Step S47, the extraction unit 102 in this embodiment (hereinafter, simply called the extraction unit 102) extracts the position information corresponding to the telephone number of the called side from the presence information table 50 in the DB server 2 based on the telephone number of the called side. Note that the processing may be performed before Step S41, or performed simultaneously with the processing at Step S41 or Step S42.

At Step S48, the extraction unit 102 selects the advertisement (the content ID) identified by the advertisement ID acquired at Step S42 from the advertising information table 60 in the DB server 2. In the case when this content ID exists plurally, the extraction unit 102 compares the priority transmission condition corresponding to each of the content IDs and the position information acquired at Step S47 to select (extract) the content ID of the priority transmission condition more matching the position information of the calling side. Note that the comparison processing at Step S48 is the same as the above-described comparison processing, and therefore explanation thereof is omitted.

Subsequently, at Step S49, the extraction unit 102 acquires the content (the advertising data) corresponding to the content ID extracted at Step S48 from, for example, the content server (not shown).

Subsequently, at Step S50, the advertising data transmission control unit 103 in this embodiment transmits the advertising data extracted at Step S49 to the mobile phone apparatus 4 being the called side.

According to this embodiment as described above, it becomes possible to transmit the advertising data to the called side as well. For example, in the case when the advertising contractant of the called side performs the contract with a confectionary manufacture and the calling side is in Hakata, the advertisement of cookies flavored with cod roe, which is a Hakata specialty, is transmitted to the calling side, and in the case when the called side is in Hokkaido, the advertisement of candy flavored with butter, which is a Hokkaido specialty, is transmitted to the called side. That is, not only can the advertising contractant have the benefit in which the telephone charge becomes free or points are added, or the like but also obtain the advertisement (for example, beneficial information and so on) of the company that the advertising contractant patronizes.

Further, according to this embodiment, the explanation is given on the assumption that the extraction unit 102 acquires the position information of the called side, but this embodiment is not limited to this, and the extraction unit 102, similarly to other embodiments, may acquire the information with regard to the called side such as the personal information, the weather information, and the time information of the called side. Then, the information processing device 1 may compare these pieces of acquired information with the priority transmission condition in the advertising information table 60 to transmit the advertising data matching the called side.

### Embodiment 8

The above-described embodiments explain the example where the called side is the advertising contractant. However, in the case when the called side and the calling side are the advertising contractans, the information processing device 1 may transmit the advertisements to the calling side and the called side before and after connecting the call.

That is, the information processing device 1 may perform processing to read “the called side” as “the calling side” in FIG. 13 simultaneously with the processing shown in FIG. 13 in Embodiment 1 and transmit the advertisement of the advertising provider with whom the called side contracts to the calling side and transmit the advertisement of the advertising provider with whom the calling side contracts to the called side.

According to each of the above-described embodiments, it becomes possible to transmit the credible and useful advertisements to the recipient. Further, the advertising contractant can enjoy advantage such as reduction of the telephone charge, a discount in conformity with it, or issue of a coupon. Further, the advertising provider can transmit the advertisements leading to sales. Further, connection to communication can be encouraged. For example, by selecting cool, pretty, or interesting advertisements, the advertising contractant can express himself/herself to the advertising transmission destination. Further, by selecting advertisements related to his/her hobby, the advertising contractant can make his/her hobby appeal to the advertising transmission destination. Further, by adding data in which a mascot or the like performs an action such as saying “Thank you for call!” in an advertising moving image, not only the general advertisement but also a new advertising expression can be generated.

Hitherto, the preferable embodiments of the present invention have been described in detail, but the present invention is not limited to such specific embodiments, and various modifications and changes can be made within the spirit of the present invention described in the claims.

For example, in the above-described embodiments, the explanation is given on the assumption that the information processing device 1 performs the telephone exchange processing and the processing with regard to transmission of the advertising data as described above, but it may be constituted such that for example, a telephone exchange or the like performs the telephone exchange processing, and the information processing device 1 performs communication with this telephone exchange, and performs the processing with regard to transmission of the advertising data as described above when receiving the telephone number of the called side included in the telephone call control signal from, for example, the telephone exchange.

Further, in the above-described embodiments, the explanation is given on the assumption that the above-described tables are stored in the HD 29 in the DB server 2 or the like, but it may be constituted such that, for example, the DB server 2 is not provided, and the tables are stored in the HD 19 in the information processing device 1 or the like.

Further, in the above-described embodiments, the explanation is given with the mobile phone apparatus, but a stationary type telephone apparatus may be used. Further, each of the above-described embodiments may be combined arbitrarily for implementation.

Further, in the above-described embodiments, the explanation is given on the assumption that the images (the moving images, the still images), the sound data, and so on are taken as the advertising data for the examples. However, the advertising data may include text, music, games, software, Web page, and so on.

Further, in the above-described embodiments, the information processing device 1 extracts the position information, the presence information, and so on of the called side or the calling side who receives the advertisement, and selects the advertising data by comparing the position information, the presence information, and so on and the priority transmission condition to transmit the advertising data so that the advertisement matching the side receiving the advertisement can be transmitted. That is, even in the case when a time difference is generated or the respective locations are different countries (regions) between the called side and the calling side, the information processing device 1 extracts the above described information with regard to the side receiving the advertisement and selects the advertising data based on the extracted information, and thereby it is possible to transmit the advertisement matching the country (the region) or the time of the side receiving the advertisement.

### INDUSTRIAL APPLICABILITY

According to the present invention, a wasteful communication packet can be reduced thereby suppressing a communication load, and an advertisement whose credibility is high, which is useful and in accordance with a recipient thereof, can be transmitted.

1-12. (canceled)

13. An information processing device comprising:
a determination unit determining whether or not a telephone number of a called side included in a received telephone call control signal is registered in an advertising contract object that is stored in a memory unit and that includes a telephone number of an advertising contractant who performs a contract with an advertising provider and advertising provider identification information identifying the advertising provider with whom the advertising contractant performs the contract;
an extraction unit extracting advertising data of the advertising provider identified by the advertising provider identification information corresponding to the telephone number of the called side from a memory unit when the telephone number of the called side is determined to be registered in the advertising contract object in said determination unit; and
an advertising data transmission control unit transmitting the advertising data extracted in said extraction unit to a telephone apparatus identified by a telephone number of a calling side included in the telephone call control signal.

14. The information processing device according to claim 13 further comprising:
a registration unit registering a telephone number identifying a telephone apparatus included in contract request information and the advertising provider identification information identifying the advertising provider in the advertising contract object in accordance with the contract request information.

15. The information processing device according to claim 13, wherein
when the telephone number of the called side is determined to be registered in the advertising contract object in said determination unit, said extraction unit extracts the advertising provider identification information registered corresponding to the telephone number of the called side from the advertising contract object and extracts the advertising data related to information with regard to the calling side from the plural pieces of advertising data of the advertising provider identified by the advertising provider identification information.

16. The information processing device according to claim 13, wherein
when the telephone number of the called side is determined to be registered in the advertising contract object in said determination unit, said extraction unit extracts the plural pieces of advertising provider identification information registered corresponding to the telephone number of the called side from the advertising contract object and extracts the advertising data related to the information with regard to the calling side from the advertising data of the plurality of advertising providers with regard to the plural pieces of advertising provider identification information.

17. The information processing device according to claim 13, wherein
when the telephone number of the called side is determined to be registered in the advertising contract object in said determination unit, said extraction unit extracts the advertising provider identification information related to the information with regard to the calling side from the plural pieces of advertising provider identification information registered corresponding to the telephone number of the called side in the advertising contract object and extracts the advertising data of the advertising provider identified by the advertising provider identification information.

18. The information processing device according to claim 15, wherein
the information with regard to the calling side is position information of the calling side, or time information when the calling side calls, or weather information in a position of the calling side, or air temperature information in the position of the calling side, or age information of the calling side, or gender information of the calling side, or a combination of these pieces of information, and
said extraction unit acquires the information with regard to the calling side from the memory unit, or acquires the information with regard to the calling side via an application.

19. The information processing device according to claim 16, wherein
the information with regard to the calling side is position information of the calling side, or time information when the calling side calls, or weather information in a position of the calling side, or air temperature information in the position of the calling side, or age information of the calling side, or gender information of the calling side, or a combination of these pieces of information, and
said extraction unit acquires the information with regard to the calling side from the memory unit, or acquires the information with regard to the calling side via an application.

20. The information processing device according to claim 17, wherein
the information with regard to the calling side is position information of the calling side, or time information when the calling side calls, or weather information in a position of the calling side, or air temperature information in the position of the calling side, or age information of the calling side, or gender information of the calling side, or a combination of these pieces of information, and
said extraction unit acquires the information with regard to the calling side from the memory unit, or acquires the information with regard to the calling side via an application.

21. The information processing device according to claim 13, wherein
when the telephone number of the called side is determined to be registered in the advertising contract object in said determination unit, said extraction unit extracts the advertising provider identification information in accordance with priority set for each advertising provider identification information from the plural pieces of advertising provider identification information registered corresponding to the telephone number of the called side in the advertising contract object and extracts the advertising data of the advertising provider identified by the advertising provider identification information.

22. The information processing device according to claim 13, wherein
said advertising data transmission control unit transmits the advertising data extracted in said extraction unit to the telephone apparatus identified by the telephone number of the calling side included in the telephone call control signal and the telephone apparatus identified by the telephone number of the called side included in the telephone call control signal.

23. The information processing device according to claim 13, wherein
said advertising data transmission control unit, in accordance with setting, transmits the advertising data after telephone communication ends, or while calling, or while performing telephone communication.

24. An advertising transmission method in an information processing device, the method comprising:
determining whether or not a telephone number of a called side included in a received telephone call control signal is registered in an advertising contract object that is stored in a memory unit and that includes a telephone number of an advertising contractant who performs a contract with an advertising provider and advertising provider identification information identifying the advertising provider with whom the advertising contractant performs the contract;
extracting advertising data of the advertising provider identified by the advertising provider identification information corresponding to the telephone number of the called side from a memory unit when the telephone number of the called side is determined to be registered in the advertising contract object in said step of determining; and
transmitting the advertising data extracted in said step of extracting to a telephone apparatus identified by a telephone number of a calling side included in the telephone call control signal.

25. A program product causing an information processing device to execute:
determining whether or not a telephone number of a called side included in a received telephone call control signal is registered in an advertising contract object that is stored in a memory unit and that includes a telephone number of an advertising contractant who performs a contract with an advertising provider and advertising provider identification information identifying the advertising provider with whom the advertising contractant performs the contract;
extracting advertising data of the advertising provider identified by the advertising provider identification information corresponding to the telephone number of the called side from a memory unit when the telephone number of the called side is determined to be registered in the advertising contract object in said sequence of determining; and
transmitting the advertising data extracted in said sequence of extracting to a telephone apparatus identified by a telephone number of a calling side included in the telephone call control signal.

26. A system comprising:
a telephone apparatus of a called side;
a telephone apparatus of a calling side; and
an information processing device, and wherein
said telephone apparatus of the called side comprises:
a contract request information transmission unit transmitting contract request information to said information processing device,
said telephone apparatus of the calling side comprises:
a telephone call control signal transmission unit transmitting a telephone call control signal to said information processing device in accordance with an operation of a user; and
an advertising data recipient unit receiving advertising data from said information processing device, and
said information processing device comprises: a registration unit registering a telephone number of an advertising contractant who performs a contract with an advertising provider included in the contract request information and advertising provider identification information identifying the advertising provider with whom the advertising contractant performs the contract in an advertising contract object in accordance with the contract request information received from said telephone apparatus of the called side;
a determination unit determining whether or not a telephone number of said telephone apparatus of the called side included in the telephone call control signal received from said telephone apparatus of the calling side is registered in the advertising contract object stored in a memory unit;
an extraction unit extracting advertising data of the advertising provider identified by the advertising provider identification information corresponding to the telephone number of said telephone apparatus of the called side from a memory unit when the telephone number of said telephone apparatus of the called side is determined to be registered in the advertising contract object in said determination unit; and
an advertising data transmission control unit transmitting the advertising data extracted in said extraction unit to said telephone apparatus of the calling side identified by the telephone number of the calling side included in the telephone call control signal.
